(19) United States
(12) Patent Application Publication
(10) Pub. No.: US 2008/0022020 A1
(43) Pub. Date: Jan. 24, 2008

(54) METHOD FOR TRANSMITTING INFORMATION BETWEEN A COMPUTER DEVICE AND A CONSUMER ELECTRIC DEVICE

(76) Inventors: Andreas ECKLEDER, Karlsbad (DE); Richard LESSER, Karlsbad (DE)

Correspondence Address: GLENN PATENT GROUP, 3475 EDISON WAY, SUITE L, MENLO PARK, CA, 94025, US

(21) Appl. No.: 11/782,476

(22) Filed: Jul. 24, 2007

Related U.S. Application Data
(63) Continuation of application No. PCT/EP05/13374, filed on Dec. 13, 2005.

(30) Foreign Application Priority Data
Jan. 25, 2005 (EP) 05001417.4

(51) Int. Cl. G06F 3/00; H04L 9/00

(52) U.S. Cl. 710/20; 726/1; 707/E17.134

(57) ABSTRACT

The present invention relates to a method for transmitting information between a computer device and a consumer electronic device (CE device) having a storage unit, the CE device being adapted to present the computer device a file system when connected with each other, having the steps of: writing a file, advantageously a small file, having a predetermined filename and containing the information to be transmitted in the file system of the CE device; reading the file having the predetermined filename and with the information contained; wherein the writing and reading steps are alternately performed by the computer device and the CE device for transmitting respective information from one device to the other.

### CROSS-REFERENCE TO RELATED APPLICATIONS

This application is a continuation of copending International Application No. PCT/EP2005/013374, filed Dec. 13, 2005, which designated the United States.

### TECHNICAL FIELD

The present invention relates to a method for transmitting information between a computer device and a consumer electronic device (CE-device) having a storage unit, the CE-device being adapted to present the computer device a file system and connected with each other.

The invention also relates to a consumer electronic device for storing data, particularly DRM protected data (digital right management protected data), and for communicating with a computer device, comprising a storage for storing said data, a controlling unit and an interface adapted to present a connected computer device as a file system.

The present invention also relates to a computer device comprising a processing unit, a storage unit and an interface unit for communicating with a CE-device, said CE-device presenting a file system when connected to said computer device.

### BACKGROUND

Consumer electric devices, like mp3-player, mpeg-2-player, etc., become more and more popular. One reason is the increasing possibilities to download digital media content, like mp3 music, mpeg-2 videos, etc. Generally, such CE devices comprise a storage unit for storing digital media content, a controller unit and an interface unit. Most commonly, the interface unit uses the standardized USB protocol and present the computer device, the CE device is connected with, a file system. This kind of CE devices belong to the USB mass storage device class.

In order to guarantee copyrights and to avoid or prohibit illegal copies of digital media content, the industry has established so called digital right management systems, however, without standardizing same. Therefore, a plurality of different right management systems exists which are not compatible with each other.

The applicant of the present invention has also introduced a digital right management system called “Nero Digital—Digital Rights Management”.

All digital right management systems work with keys necessary for encrypting and decrypting the digital media content, many of which are provided by a key server.

With respect to robustness and safety of the digital right management systems it is of great importance that these keys are not transmitted via unsecured channels. Otherwise, the transmitted key could be captured and illegally used to copy digital media content. Therefore, the whole communication is encrypted using a common key. This key is normally established during an authentication procedure between e. g. the CE device and the computer device. The authentication procedure, however, necessitates a bi-directional communication path between the CE device and the computer device.

In view of the used CE devices, which are often inexpensive USB stick mp3-player, the interface for communicating with a computer device should be as simple as possible but should nevertheless allow a communication between the CE device and the computer device.

### SUMMARY

According to an embodiment, a method for transmitting information between a computer device and a consumer electronic device having a storage unit, the consumer electronic device being adapted to present the computer device a file system when connected to the computer device, may have the steps of: by the computer device, writing a first file having a first predetermined file name, the file including information to be transmitted to the consumer electronic device, in the file system of the consumer electronic device; by the consumer electronic device, watching the file system for the first file having the first predetermined file name; by the consumer electronic device, when the first file having the first predetermined file name is detected, reading the file having the first predetermined file name and processing data read from the first file; by the consumer electronic device, when the consumer electronic device wants to transmit data to the computer device as a response, writing a second file having a predetermined file name to the file system of the consumer electronic device, the second file having the data to be transmitted to the computer device; by the computer device, monitoring the file system of the consumer electronic device for a second file having the second predetermined file name; and by the computer device, when the second file having the second predetermined file name is detected, reading the data from the second file and processing data read from the second file.

According to another embodiment, a consumer electronic device for storing data, and for communicating with a computer device, having a storage unit for storing the data, a controller unit and an interface adapted to present a connected computer device a file system, may have: a monitoring element adapted to watch the file system for a first file having a first predetermined file name, a processing element adapted to read and process data stored in the first file having the first predetermined file name when the first predetermined file name is detected by the monitoring element, and a transmitting element adapted to create a second file having a second predetermined file name, when the consumer electronic device wants to transmit data to the computer device as a response, the second file including the data to be transmitted to the computer device.

According to another embodiment, a computer device having a processor unit, a storage unit and an interface unit for communicating with a consumer electronic device, the consumer electronic device presenting a file system when connected to the computer device, may have: a monitoring element adapted to watch the presented file system for a first file having a first predetermined file name, a processing element adapted to read and process data stored in the first file having the first predetermined file name, when the first predetermined file name is detected by the monitoring element; and a transmitting element adapted to create a second file having a second predetermined file name, when the computer device wants to transmit data to the consumer electronic device as a response, the second file including the data to be transmitted to the consumer electronic device.

According to another embodiment, an apparatus for transmitting information between a computer device and a consumer electronic device having a storage unit, the consumer electronic device being adapted to present the computer device a file system when connected to the computer device, may have: in the computer device, a writer for writing a first file having a first predetermined file name, the file including information to be transmitted to the consumer electronic device, in the file system of the consumer electronic device; in the consumer electronic device, a watcher for watching the file system for the first file having the first predetermined file name; in the consumer electronic device, a reader for reading the file having the first predetermined file name and processing data read from the first file, when the first file having the first predetermined file name is detected; in the consumer electronic device, a writer for writing a second file having a predetermined file name to the file system of the consumer electronic device when the consumer electronic device wants to transmit data to the computer device as a response, the second file having the data to be transmitted to the computer device; in the computer device, a monitorer for monitoring the file system of the consumer electronic device for the second file having the second predetermined file name; and in the computer device, a reader for reading the second file and processing the data read from the second file, when the second file having the second predetermined file name is detected.

According to another embodiment, a method of storing data and of communicating with a computer device, in a consumer electronic device having a storage unit for storing the data, a controller unit and an interface adapted to present a connected computer device a file system, may have the controller unit perform the steps of: watching the file system for a first file having a first predetermined file name, reading and processing data stored in the first file having the first predetermined file name, when the first predetermined file name is detected in the step of watching, and creating a second file having a second predetermined file name, when the consumer electronic device wants to transmit data to the computer device as a response, the second file including the data to be transmitted to the computer device.

According to another embodiment, a method of communicating from a computer device having a processor unit, a storage unit and an interface unit to a consumer electronic device, the consumer electronic device presenting a file system when connected to the computer device, may have the steps of: watching the presented file system for a first file having a first predetermined file name, reading and processing data stored in the first file having the first predetermined file name, when the first predetermined file name is detected in the step of watching; and creating a second file having a second predetermined file name, when the computer device wants to transmit data to the consumer electronic device as a response, the second file including the data to be transmitted to the consumer electronic device.

That is in other words, the information or data transmission from one device to the other is performed by writing and reading small files to and from the storage of the CE device, the file containing the respective data. Due to that inventive approach of transmitting information, the interface of the CE device does not have to be modified for example by incorporating a TCP/IP stack. Rather, the inventive method uses the USB protocol for USB mass storage devices for carrying out a bidirectional communication.

Since the transmitted files are small, advantageously between a few bytes to a few kilobytes, this method may be applicable for any CE device handled as a mass storage device when connected to a computer device, because of the low storage requirements for example.

It is apparent that the steps of writing a file and reading that file are alternately performed by the computer device and the CE device in case of a bi-directional communication. That is, e.g., the computer device writes a file containing data to be transmitted, to the storage unit of the CE device. The CE device detects this file, reads the data out of the file and processes the data. The CE device then also writes a file containing the data to be transmitted to the computer device. The computer device detects this new file, reads the data out of the file and processes the data. If the computer device has further data to be transmitted, the afore mentioned steps will be repeated.

In an embodiment, the file name is changed with each writing step in a predetermined manner, advantageously by increasing a number being part of the file name by one.

This means in other words that each file written during a particular transmitting step has a unique file name. This is important as to identify which files have already been written and read by one of the devices. Particularly, each CE device and the computer device each knows which files have to be read on the basis of the unique file names. In case of a file name having a number as a portion of the file name, the devices may recognize which files are written by the other device.

In an embodiment, the file having a former file name is deleted in the file system.

In other words, the files which have already been read are deleted. This measure has the advantage that less memory is occupied by the transmitting procedure.

In a further embodiment, said CE device is a mass storage device, advantageously a USB mass storage device.

The present invention is particularly useful with such USB mass storage devices. However, it is to be noted that the inventive method is also applicable to other CE devices using for example the firewire protocol. In all conceivable cases, the CE device is adapted to present the connected computer device a file system, so that both devices are allowed to write and read files to and from the same memory unit.

In an embodiment, said CE device is an mp3-player.

In a further embodiment, said information is data necessary for calculating a bus key common for both devices and necessitated by a digital right management system for encryption and decryption.

The inventive method is particularly useful for transmitting data during an authentication process necessary for establishing a bus key common for both devices. The afore mentioned “Nero Digital” DRM system uses for example such a bus key which is calculated by the involved devices during the authentication.

In a further embodiment, said files are stored in a predetermined folder of the file system of the CE device. More particularly, the files contained in said folder are deleted before writing the first file.

The object of the present invention is also solved by a consumer electronic device for storing data, particularly DRM protected data, and for communicating with a computer device, comprising a storage unit for storing said data, a controller unit and an interface unit adapted to present a connected computer device a file system, said controller unit comprising a monitoring element adapted to watch the file system for a file having a predetermined receiving file name and stored by said connected computer device, a processing element adapted to read and process data stored in said file, and a transmitting element adapted to create a new file having a predetermined transmitting file name and containing data to be transmitted to the computer device.

In other words, the controller unit is designed (hardware or software based) to have a monitoring element which controls the file system and detects a file having a predetermined receiving file name. If such a file is detected, the processing element reads and processes the data stored in said file. In the event that the consumer electronic device wants to transmit data—as a response—to a the computer device, the transmitting element creates a new file having a predetermined transmitting file name and containing the data to be transmitted to the computer device. This file is then stored also in the file system of the CE device.

The advantage of the inventive consumer electronic device is that a bi-directional communication with a computer device is possible without the need to implement for example a TCP/IP stack, for a standard TCP/IP communication. Instead, the file system is used for communication between both devices.

In an embodiment, said interface is a USB interface. More advantageously, said CE device is a mass storage device, advantageously a USB or firewire mass storage device. Advantageously, said device is an mp3-player. USB and firewire interfaces are the most common interfaces with consumer electronic devices and therefore the present invention is particularly useful.

The object of the present invention is also solved by a computer device of the afore mentioned kind, said processor unit comprising a monitoring element adapted to watch the presented file system for a file having a predetermined receiving file name, a protecting element adapted to read and process data stored in said file, and a transmitting element adapted to create a new file having a predetermined transmitting file name and containing data to be transmitted to the CE device.

It is apparent that the computer device has the same functional structure as the consumer electronic device as mentioned before. Therefore, it is referred to the description above in order to avoid repetitions.

In an embodiment, said interface unit is a USB or a firewire interface unit. More advantageously, the computer device is a personal computer. However, the present invention is not limited to personal computers. Instead, the computer device may also be a set-top box or any other device allowing the connection of a mass storage device.

Further features and advantages can be taken from the following description and the enclosed drawings.

It is to be understood that the features mentioned above and those yet to be explained below can be used not only in the respective combinations indicated, but Lalso in other combinations or in isolation, without leaving the scope of the present invention. With other words, even if two or more features are mentioned in a single claim, this is not to be considered as limiting the invention to this combination only. Rather, each single feature of the claim may be combined with the features of the other claims.

### BRIEF DESCRIPTION OF THE DRAWINGS

Embodiments of the present invention will be detailed subsequently referring to the appended drawings, in which:

FIG. 1 is a block diagram for illustrating the inventive method;

FIG. 2 is a schematic block diagram of a computer device and a CE device; and

FIG. 3 is a schematic diagram for illustrating the procedure for establishing a common bus key necessary in a digital rights management system.

### DETAILED DESCRIPTION

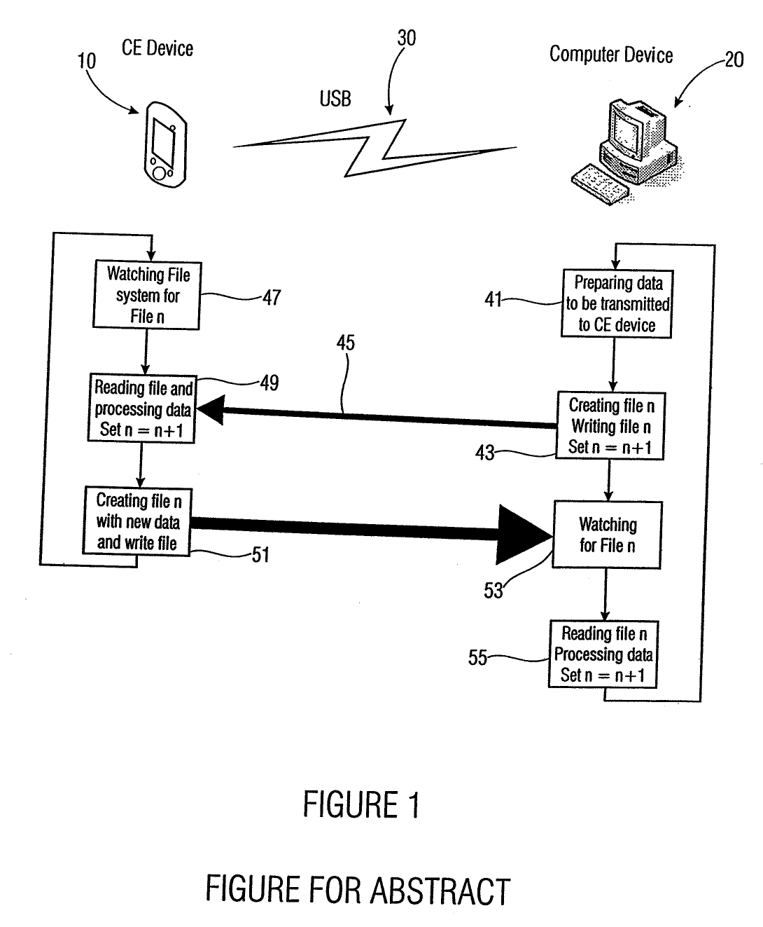

In FIG. 1 a CE device indicated with reference numeral 10 and a computer device indicated with reference numeral 20 are schematically shown. The CE device 10 may be for example a PDA (Personal Digital Assistant), an mp3-player, an mpeg-2 or mpeg-4-player, a mobile phone, etc. The computer device 20 may be for example a personal computer, a set top box or the like.

Both devices 10, 20 have in common an interface allowing a connection with each other for transmitting data. This connection is indicated with an arrow referenced with reference numeral 30. In the present embodiment, both interfaces are USB interfaces. Further, the CE device 10 belongs to the USB mass storage device class meaning that it presents the computer device 20 a file system or file system volume when connected. That is, if the user connects the CE device 10 and the computer device 20 via a USB cable, the computer device 20 recognizes the CE device as a mass storage device and presents the user a new mass storage volume. The user may then read and write files from and to this new volume.

It is, however, to be noted that the present invention should not be limited to the USB based communication. Rather, other protocols like for example firewire protocol, are also applicable. The only requirement is that the CE device 10 presents the computer device 20 a file system.

In particular applications, for example in an authentication procedure for establishing a bus key necessary for a digital rights management, data have to be exchanged between the CE device 10 and the computer device 20. Such a communication between the CE device 10 and the computer device 20 is not performed via for example the standard TCP/IP protocol but on the basis of the USB mass storage device protocol as will be explained below.

It is assumed that the computer device 20 has to transmit specific data to the CE device 10. As shown in FIG. 1, right column, this specific data is prepared to be transmitted to the CE device, block 41. Preparing means for example to bring the data in the appropriate format. Then, the computer device 20 creates a file, for example with a file name “dpac.xxx”, where xxx is a sequence number n starting from “000” for the initial first file. The created file “dpac.000”, e.g., is written to the mass storage volume of the CE device 10 (block 43). This writing step is indicated by an arrow 45. Then, the sequence number n is increased by 1. The sequence number is then “001”.

It is to be noted that the created file “dpac.000” may be stored in the route path of the mass storage device volume or in any folder thereof. The created file may be stored in a dedicated folder, for example a folder “nddrm.ath”.

At the same time, the CE device 10 watches the file system, particularly the dedicated folder “nddrm.ath” for a file “dpac.xxx”. Particularly, the file “dpac.000” is expected (block 47). If the CE device 10 detects the file “dpac.000” in the dedicated folder, the file is read and the data therein is processed (block 49). Further, the sequence number n is increased by 1, that is the sequence number is then “001”.

At this point, the transmission of a first data packet contained in the file “dpac.000” has been terminated.

If the CE device 10 has to transmit a response to the computer device 20, the data is prepared and a file is created containing the prepared data.

The created file has the file name “dpac.001” and is written to the dedicated folder “nddrm.ath” of the mass storage device volume (block 51).

At the same time, the computer device 20 monitors or watches the USB mass storage device volume, particularly the dedicated folder for a file “dpac.001” (block 53). Since the CE device 10 has written this file, the computer device 20 detects this file in the dedicated folder and in response thereto reads the file and processes the data stored therein, (block 55). Then, the sequence number n (currently 001) is increased by 1 and is hence “002”.

If the computer device 20 has further data to be transmitted to the CE device 10, the above-mentioned procedure starting with block 41 is performed again.

It is apparent from the above description that the communication between the computer device 20 and the CE device 10 is performed by writing and reading files containing the data to be transmitted.

After reading the file in the dedicated folder the file may be deleted as to keep the amount of occupied memory as small as possible. Further, before writing the initial packet with the file having the sequence number 000, the computer device 20 makes sure that no files from a previous transmission procedure exist in the dedicated folder. If former files still exist, the files are deleted.

It is also to be noted that the transmission process will be terminated if the CE device of the computer device watches the dedicated folder longer than a predetermined time period (for example 3 seconds) before detecting a file. This has the advantage that both devices 10, 20 have not to transmit any data indicating the end of the transmission of data. The transmission will automatically be terminated after a predetermined time period of no writing.

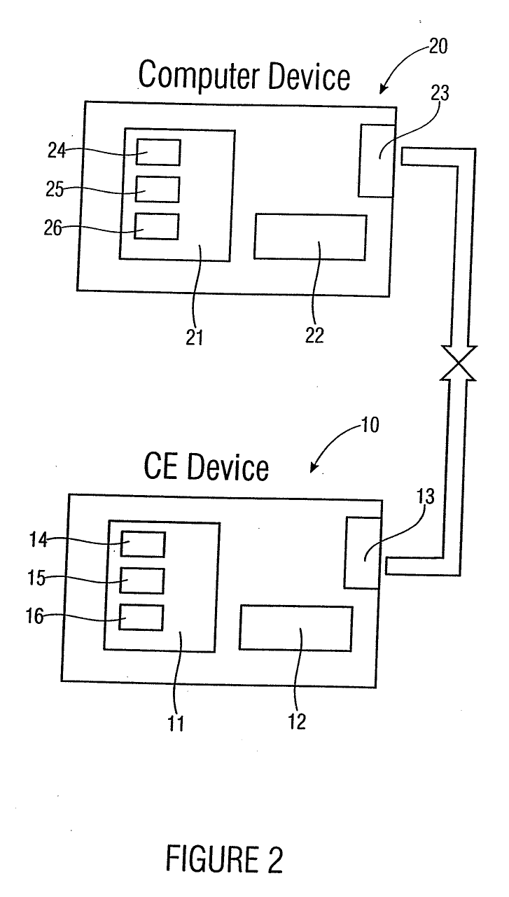

In FIG. 2, the structure of the computer device 20 and the CE device is schematically shown. The computer device 20 comprises at least a controller unit 21, a storage unit 22 and an interface unit 23. The controller unit 21 is for example a microprocessor, and the interface unit 23 is an USB interface.

The controller unit 21 comprises a monitoring element 24, a processing element 25 and a transmitting element 26. These elements 24, 25, 26 are adapted to perform the method steps mentioned above. Particularly, the monitoring element is adapted to watch the file system for a file having a predetermined receiving file name. The processing element 25 is adapted to read and process data stored in said file. The transmitting element 26 is adapted to create a new file having a predetermined transmitting file name and containing data to be transmitted to. Generally, all three elements 24-26 are provided in form of software modules. However, it is also possible that they are provided as hardware elements.

The transmitting element 26 supplies the new file to the USB interface 23 which in turn transmits this file to the connected CE device.

The CE device can also comprise a controller unit 11, a storage unit 12 and an interface unit 13. The controller unit 11 is provided as a processor. The interface unit 13 is provided as a USB-interface.

To perform the above mentioned transmission steps, the controller unit 11 comprises a monitoring element 14, a processing element 15 and a transmitting 16. The monitoring element 14 is adapted to watch the presented file system for a file having a predetermined receiving file name. The processing element 15 is adapted to read and process data stored in said file, and said transmitting element 16 is adapted to create, a new file having a predetermined transmitting file name and containing data to be transmitted to the computer device. Similar to the computer device 20, the elements 14, 15 and 16 may be provided as software or hardware modules.

As already mentioned before, the method described with reference to FIG. 1 is of particular relevance in connection with Nero Digital—Digital Rights Management. The above transmission method may specifically be used for components authentication.

Usually, key exchange procedures used for digital rights management systems are protected by an authentication procedure establishing a bus key by exchanging key fragments and random numbers encrypted using key sets private to both keys, for example a CE device and a computer device. For communication with USB mass storage devices (CE devices), the source initiates the negotiation process by placing data packets at specified location. The communication partner (CE device) is expected to be in listening (watching mode).

All communication starts with establishing a bus key used for transferring license information. The authentication procedure is based on AES encryption which is known in the art. Each component with support for bus key authentication (CE device, desktop PC software, licensing server, . . . ) will be assigned an unique component ID and a private set of keys which are used to authenticate the device and to lock out compromised devices. Component IDs and keys are maintained by Nero AG, each developer of a Nero Digital DRM enabled component must request a component ID and associated keys as part of the licensing procedure for a Nero Digital DRM technology.

Using the component ID and the licensed keys, the listening component is able to calculate a key KRₐᵤₜₕ₁ that is also known to the active component. Furthermore, the active component's component ID allows the active component to calculate a key KRₐᵤₜₕ₂ that is also known to the listening component.

The version number transferred during the authentication procedure is referring to the authentication process only. More specifically, it does not specify the version of the content protocol making use of the bus key obtained as a result of the authentication procedure, and it does not specify the version of the low-level transport protocol used for transferring authentication packets (e.g. authentication procedure for licensing servers and shopping servers, authentication procedure for CE devices without internet connection).

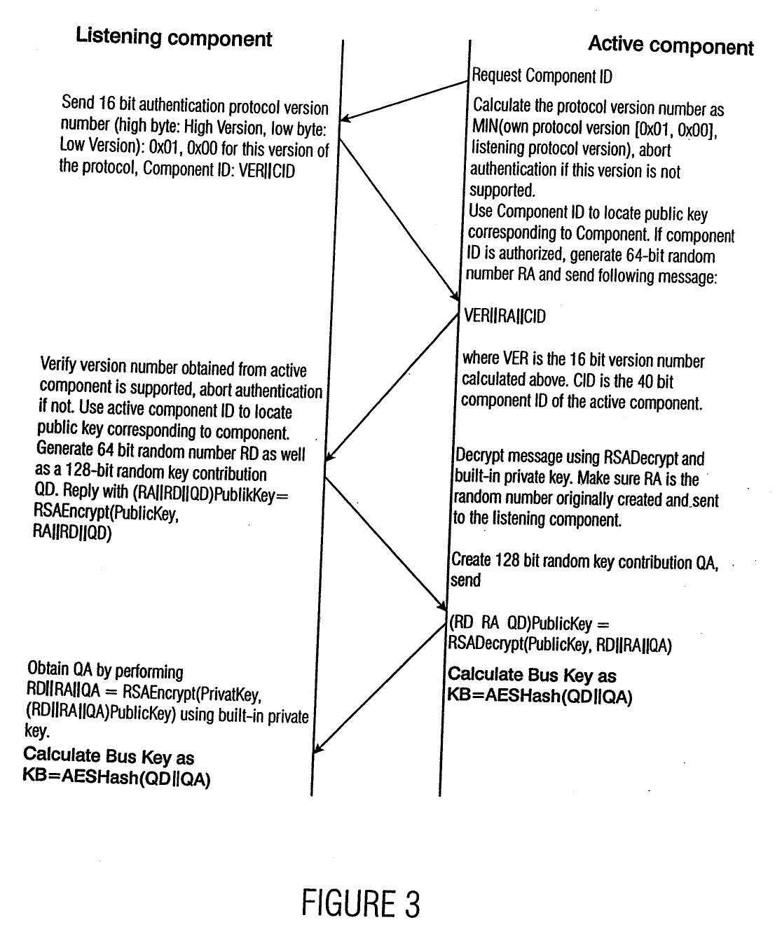

An example of an authentication procedure using a public key encryption is shown in FIG. 3. Here, the symbol ‘∥’ specifies the sequential concatenation of two blocks of data.

The symbol ⊕ specifies a bit-wise exclusive or operation applied to two blocks of data.

The synchronous block, cipher algorithm used for Nero Digital DRM is AES in 128-bit key mode (AES-128):
AES encryption of a 128-bit plain text block m to a 128-bit cipher text block c using a 128-bit key k is specified as c=AESEncrypt(k, m) in this document.
Decryption is specified as m=AESDecrypt(k, c).

The AES Hash algorithm h=AESHash(m) is used to calculate a hash value over a sequence m of 17 or more bytes. The sequence m shall be padded at the end by the shortest amount of zeros (bytes of value 0×00), such that m consists of two or more consecutive 128-bit blocks mᵢ, i=0. last. The result is a single 128-bit value h, which shall be calculated from the equations
h₁=AESEncrypt(m₀, m₁)⊕m₁;
hᵢ=AESEncrypt(hᵢ₋₁, mᵢ)⊕mᵢ; i=2 . . . last−1;
h=AESEncrypt (hₗₐₛₜ₋₁, mₗₐₛₜ)⊕mₗₐₛₜ

All intermediate values hᵢ shall be discarded.

Ciphertext=RSAEncrypt(PublicKey, Plaintext) and Plaintext=RSADecrypt(PrivateKey, Ciphertext) denote encryption/decryption using the RSA encryption algorithm. PublicKey specifies the public key to be used for encryption, PrivateKey denotes the private key to be used for decryption. Ciphertext is a block of encrypted data while Plaintext is a block of unencrypted data.

It is to be noted that the authentication procedure shown in FIG. 3 is just one example of a plurality of conceivable procedures and shall not limit the invention.

As a general rule, all newer components have to support old versions of the authentication procedure unless explicitly specified by Nero AG. Support for outdated versions of the authentication protocol shall be dropped upon notice to do so.

Depending on the kind of transaction, the active component will either actively push a license to the listening component or fetch a license off the specifying the purpose for witch a license is to be obtained (in example playback, transfer to CE device to or physical medium, transferring transmission from one license account to another, checking whether a specific operation is covered by a license.

All communication after negotiating the bus key must be encrypted using the bus key.

The active component in transferring licenses to a CE device is the originating system, in example a computer device, a personal computer or a set-top box. The data packets mentioned in FIG. 3 are transmitted from the originating system, namely the computer device, to the listening component, namely the CE device by using the method as described with reference to FIG. 1. As soon as the steps shown in FIG. 3 are performed, the common bus key is known to the computer device 20 as well as to the CE device 10. On the basis of this bus key, all further communication between both devices may be encrypted.

It is to be noted that during establishing the bus key, no relevant data allowing reconstructing the bus key is transmitted between the devices. Further, it is to be noted that the CE device does not need to have a TCP/IP stack or the like allowing a standard bi-directional communication.

Those skilled in the art can now appreciate from the foregoing description that the broad teaching of the present invention can be implemented in a variety of forms. Therefore, while this invention has been described in connection with a particular example-thereof, the true scope of the invention should not be so be limited since other modification will become apparent to the skilled practitioner upon a study of the drawing, specification and the claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A method for transmitting information between a computer device and a consumer electronic device comprising a storage unit, the consumer electronic device being adapted to present the computer device a file system when connected to the computer device, comprising:
by the computer device, writing a first file comprising a first predetermined file name, the file including information to be transmitted to the consumer electronic device, in the file system of the consumer electronic device;
by the consumer electronic device, watching the file system for the first file comprising the first predetermined file name;
by the consumer electronic device, when the first file comprising the first predetermined file name is detected, reading said file comprising said first predetermined file name and processing data read from the first file;
by the consumer electronic device, when the consumer electronic device wants to transmit data to the computer device as a response, writing a second file comprising a predetermined file name to the file system of the consumer electronic device, the second file comprising the data to be transmitted to the computer device;
by the computer device, monitoring the file system of the consumer electronic device for a second file comprising the second predetermined file name; and
by the computer device, when the second file comprising the second predetermined file name is detected, reading the data from the second file and processing data read from the second file.

2. The method according to claim 1, in which the first predetermined file name is changed in predetermined manner to obtain the second predetermined manner to obtain the second predetermined file name

3. The method according to claim 2, in which the first predetermined file name includes a sequence number and the second predetermined file name includes a sequence number being different from the first sequence number.

4. The method according to claim 1, wherein said consumer electronic device is a mass storage device, advantageously a USB mass storage device.

5. The method according to claim 4, wherein said consumer electronic device is a mp3-player.

6. The method according to claim 1, wherein said information is necessary for calculating a bus key common for both devices and necessitated by a digital rights management system for encryption.

7. The method according to claim 1, wherein said files are stored in a predetermined folder of the file system of the consumer electronic device.

8. The method according to claim 7, wherein the files included in said folder are deleted before writing the first file.

9. A consumer electronic device for storing data, and for communicating with a computer device, comprising a storage unit for storing said data, a controller unit and an interface adapted to present a connected computer device a file system, wherein said controller unit comprises:
a monitoring element adapted to watch the file system for a first file comprising a first predetermined file name,
a processing element adapted to read and process data stored in said first file comprising the first predetermined file name when the first predetermined file name is detected by the monitoring element, and
a transmitting element adapted to create a second file comprising a second predetermined file name, when the consumer electronic device wants to transmit data to the computer device as a response, the second file including the data to be transmitted to the computer device.

10. The consumer electronic device according to claim 9, wherein said interface is a USB interface.

11. The -consumer electronic device according to claim 9, wherein said consumer electronic device is a mass storage device, advantageously a USB or firewire mass storage device.

12. The consumer electronic device according to claim 9, wherein said device is an mp3-player.

13. A computer device comprising a processor unit, a storage unit and an interface unit for communicating with a consumer electronic device, said consumer electronic device presenting a file system when connected to said computer device, wherein said processor unit comprises:
a monitoring element adapted to watch the presented file system for a first file comprising a first predetermined file name,
a processing element adapted to read and process data stored in said first file comprising the first predetermined file name, when the first predetermined file name is detected by the monitoring element; and
a transmitting element adapted to create a second file comprising a second predetermined file name, when the computer device wants to transmit data to the consumer electronic device as a response, the second file including the data to be transmitted to the consumer electronic device.

14. The computer device according to claim 13, wherein said interface unit is a USB or a firewire interface unit.

15. The computer device according to claim 13, wherein it is provided as a personal computer.

16. The computer device according to claim 13, wherein it is provided as a set-top box.

17. An apparatus for transmitting information between a computer device and a consumer electronic device comprising a storage unit, the consumer electronic device being adapted to present the computer device a file system when connected to the computer device, comprising:
in the computer device, a writer for writing a first file comprising a first predetermined file name, the file including information to be transmitted to the consumer electronic device, in the file system of the consumer electronic device;
in the consumer electronic device, a watcher for watching the file system for the first file comprising the first predetermined file name;
in the consumer electronic device, a reader for reading said file comprising said first predetermined file name and processing data read from the first file, when the first file comprising the first predetermined file name is detected;
in the consumer electronic device, a writer for writing a second file comprising a predetermined file name to the file system of the consumer electronic device when the consumer electronic device wants to transmit data to the computer device as a response, the second file comprising the data to be transmitted to the computer device;
in the computer device, a monitorer for monitoring the file system of the consumer electronic device for the second file comprising the second predetermined file name; and
in the computer device, a reader for reading the second file and processing the data read from the second file, when the second file comprising the second predetermined file name is detected.

18. A method of storing data and of communicating with a computer device, in a consumer electronic device comprising a storage unit for storing said data, a controller unit and an interface adapted to present a connected computer device a file system, wherein said controller unit being adapted to perform the following steps:
watching the file system for a first file comprising a first predetermined file name,
reading and processing data stored in said first file comprising the first predetermined file name, when the first predetermined file name is detected in the step of watching, and
creating a second file comprising a second predetermined file name, when the consumer electronic device wants to transmit data to the computer device as a response, the second file including the data to be transmitted to the computer device.

19. The method according to claim 18, in which the step of creating the second file is performed, when the consumer electronic device has to transmit a response to the data read from the first file.

20. A method of communicating from a computer device comprising a processor unit, a storage unit and an interface unit to a consumer electronic device, said consumer electronic device presenting a file system when connected to said computer device, comprising:
watching the presented file system for a first file comprising a first predetermined file name,
reading and processing data stored in said first file comprising the first predetermined file name, when the first predetermined file name is detected in the step of watching; and
creating a second file comprising a second predetermined file name, when the computer device wants to transmit data to the consumer electronic device as a response, the second file including the data to be transmitted to the consumer electronic device.

21. The method according to claim 20, in which the step of creating the second file is performed, when the computer device has to transmit a response to the data read from the first file.
